(19) United States
(12) Patent Application Publication
(10) Pub. No.: US 2012/0287343 A1
(43) Pub. Date: Nov. 15, 2012

(54) DISPLAY SYSTEM

(75) Inventors: Michael Kelly, Deerfield Beach, FL (US); Teerapat Theerawong, Delray Beach, FL (US); Yuval Shohet, Acton, MA (US)

(73) Assignee: OPENPEAK INC., Boca Raton, FL (US)

(21) Appl. No.: 13/281,263

(22) Filed: Oct. 25, 2011

Related U.S. Application Data
(60) Provisional application No. 61/406,522, filed on Oct. 25, 2010.

(51) Int. Cl. H04N 3/27

(52) U.S. Cl. 348/554; 348/E03.049

(57) ABSTRACT

A display system is described that extends the functionality of a mobile display device such that video content generated thereby can be displayed by a different display device, wherein such video content may be the same as or different from video content currently being displayed by the mobile display device. This may be achieved when the mobile display device is engaged with a docking station that provides one or more of power, an extended user interface, network connectivity, and audio/video output features to the mobile display device. Such docking station may include a video interface for connecting the docking station to the different display device. When the mobile display device is engaged with the docking station and the docking station is connected to the different display device via the video interface, video content can be routed from the mobile display device to the different display device.

### CROSS-REFERENCE TO RELATED APPLICATIONS

This application claims priority to U.S. Provisional Patent Application No. 61/406,522, filed Oct. 25, 2010 and entitled “Display System,” the entirety of which is incorporated by reference herein.

### FIELD OF TECHNOLOGY

The subject matter described herein is generally directed to mobile display devices and more particularly, to mobile display devices that can be connected to a docking station and other peripherals to extend the functionality thereof.

### BACKGROUND

There exist a wide variety of mobile devices that include a display for viewing video content thereon. Such mobile display devices include but are not limited to smart phones, tablet computers, netbooks, laptop computers, personal media players, handheld game consoles, and the like. For reasons relating to portability and battery life, these mobile display devices are typically limited to relatively small physical dimensions. As such, the displays for these devices may be small and difficult to see or use for large portions of the population. Consequently, there is a need to increase the utility of such mobile display devices, particularly without expanding their physical dimensions or increasing the costs thereof.

### SUMMARY

A display system is described herein that enables the functionality of a mobile display device to be extended such that video content generated by the mobile display device can be displayed by a different display device, which may, for example, include a larger display. The video content that is displayed by the different display device can be the same as or different from video content that is being displayed on a display of the mobile display device. In accordance with certain embodiments, this extension of the functionality of the mobile display device can be achieved when the mobile display device is engaged with a docking station that provides one or more of power, an extended user interface, network connectivity, or audio/video output features to the mobile display device. Such docking station may include a video interface for connecting the docking station to the different display device. When the mobile display device is engaged with the docking station and the docking station is connected to the different display device via the video interface, video content can be routed from the mobile display device to the different display device.

In accordance with such a configuration, a processing unit on the docking station can be used to convert the format of the video content received from the mobile display device to a format that is supported by the video interface used to connect to the different display device. Such processing unit may also be used to convert the video content from a first display resolution that is supported by the mobile display device to a second display resolution that is supported by the different display device but is not supported by the mobile display device. For example, the processing unit may upscale the video content. The processing unit may also operate to ensure that the video content received from the mobile display device is provided at a maximum display resolution that does not exceed the maximum display resolution of the different display device.

In accordance with a further embodiment, the docking station may be configured to transmit an indicator to a processing unit on the mobile display device that indicates that no display device is currently connected to the video interface of the docking station and, in response to receiving such an indicator, the processing unit on the mobile display device may cause the processing unit on the docking station to be powered down.

In accordance with yet another embodiment, the mobile display device may also include a video interface that enables the mobile display device to be directly connected to a different display device and to transmit video content thereto.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a display system in accordance with an embodiment that extends the functionality of a mobile display such that video content generated by the mobile display device can be displayed by a different display device.

FIG. 2 depicts a flowchart of a method implemented by a docking station for controlling the display resolution of video content received from a mobile display device engaged therewith and/or video content output to a display device connected thereto in accordance with an embodiment.

FIG. 3 depicts a flowchart of a method by which a mobile display device can selectively power down a processing unit of a docking station with which the mobile display device is engaged in accordance with an embodiment.

FIG. 4 is a block diagram of an example docking interface that can be used to connect a mobile display device to a docking station in accordance with an embodiment.

FIG. 5 is a block diagram of an example computer system that may be used to implement one or more aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### A. Introduction

The following detailed description refers to the accompanying drawings that illustrate exemplary embodiments. However, the scope of the subject matter presented herein is not limited to these embodiments, but is instead defined by the appended claims. Thus, embodiments beyond those shown in the accompanying drawings, such as modified versions of the illustrated embodiments, may nevertheless be encompassed by the claims. Furthermore, numerous specific details are set forth herein in order to provide a thorough understanding of the described embodiments. However, it will be understood by persons skilled in the relevant art(s) that the embodiments described herein can be practiced without these specific details. In other instances, methods, procedures and components have not been described in detail so as not to obscure the related relevant feature being described. Also, the description is not to be considered as limiting the scope of the embodiments described herein.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Several definitions that apply throughout this document will now be presented. The word “plurality” means a number that is greater than one. A “display” is an interface that is capable of presenting images and/or other information in a form that is viewable by a human. “Video content” is defined as any information that can be viewed by a human via a display, and includes but is not limited to text, still images, moving images, animations, graphically-rendered images and objects, and the like. A “display device” is defined as an electronic device that includes a display, is connected to a display, or otherwise provides access to a display. A “mobile electronic device” is defined as an electronic device that is designed to be and/or is capable of being carried by a human. A “mobile display device” is defined as a mobile electronic device that includes a display, is connected to a display, or otherwise provides access to a display.

A “processing unit” is defined as a component or group of components that is configured to conduct various operations that manipulate or process data. The word “data” is defined as all forms of information that are capable of being generated and at least temporarily stored. A “video interface” is defined as a component or a group of components that enables two or more separate systems or components to be connected such that signals that represent at least video content can be transmitted or exchanged between or among them. A “network” is defined as a collection of two or more systems or components in which the systems or components are permitted to at least exchange signals with one another, and includes centrally managed, peer-to-peer or asynchronous arrangements and simple one-to-one connections. A “network interface” is defined as an interface that enables a system or component to be connected to a network and exchange signals thereon.

A “docking station” is defined as a component or a group of components that is configured to receive (not necessarily through a physical connection) a mobile electronic device and transfer signals to and from the mobile electronic device. A “docking interface” is a component or a group of components that enable or at least assist in enabling two or more separate elements to interact with another or become engaged with one another and is not limited to physical connectivity. A “detection component” is defined as a component or group of components that is capable of detecting an engagement or disengagement of two or more interfaces or other elements.

A “user interface” is defined as any interface that enables human interaction with a machine. A “touch screen display” is a display in which at least a portion of the display is capable of receiving user directed commands initiated by direct physical contact of a human finger or other physical device or through touchless interaction between the display and the finger or physical device within a predetermined distance of the display. The term “control element” means an element that is capable of being manipulated by a human for purposes of entering commands or causing some associated action in a device that presents or contains the element.

### B. Example Display System

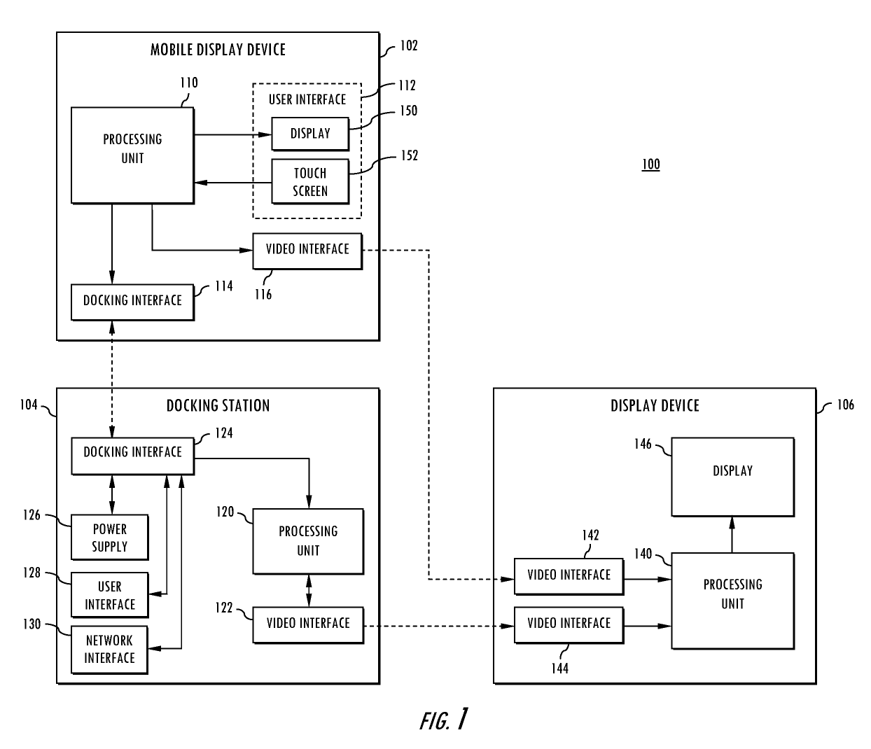

FIG. 1 is a block diagram of an example display system 100 in accordance with an embodiment. As shown in FIG. 1, display system 100 includes a mobile display device 102, a docking station 104 and a display device 106. As will be discussed below, display system 100 enables the functionality of mobile display device 102 to be extended such that video content generated by mobile display device 102 can be displayed by a different display device, such as display device 106.

In one embodiment, mobile display device 102 comprises a tablet computer. However, this example is not intended to be limiting, and mobile display device 102 may also comprise a smart phone, a netbook, a laptop computer, a personal media player, a handheld game console, or any other mobile electronic device that includes or otherwise provides access to a display. As shown in FIG. 1, mobile display device includes at least a processing unit 110, a user interface 112, a docking interface 114, and a video interface 116.

Processing unit 110 is configured to conduct various operations that manipulate or process data. Processing unit 110 may represent one or more general-purpose or special-purpose processors or processor cores that are configured to execute instructions in a well-known manner. Processing unit 100 may additionally or alternatively represent one or more application-specific integrated circuits, gate arrays, or other structures designed to perform particular operations. The types of operations performed by processing unit 110 will vary depending upon the functionality that is to be provided by mobile display device 102. For example, in accordance with certain embodiments, processing unit 110 may be configured to initiate a connection to a communications network (not shown), and to cause signals to be exchanged with the network. Such connection may comprise a wireless or wired connection and may allow a user of mobile display device 102 to access various services or features available over the network. For example, through the network, a user may download and install various applications on mobile display device 102.

User interface 112 is a component of mobile display device 102 that enables a user thereof to interact with mobile display device 102. In the embodiment shown in FIG. 1, user interface 112 includes at least a display 150 and a touch screen 152. Display 150 is intended to represent a component that is capable of presenting images and/or other information in a form that is viewable by a user of mobile display device 102. Touch screen 152 is intended to represent a component that can detect the presence and location of a touch within a display area of display 150, thereby enabling a user of mobile display device 102 to provide touch-based input thereto. Taken together, display 150 and touch screen 152 may comprise what is referred to as a touch screen display. Mobile display device may 102 may also include other types of user interface components, including but not limited to keypads, touch pads, keyboards, mice, accelerometers, microphones, speakers, or the like.

Video interface 116 comprises one or more components that enable mobile display device 102 to be connected to another device, such as display device 106, for at least the purpose of transmitting signals representing video content thereto. Depending upon the implementation, video interface 116 may be capable of transmitting signals representing audio content as well as video content, and may further operate to transmit or receive control signals. In one embodiment, video interface 116 comprises a High-Definition Multimedia Interface (HDMI) interface that enables mobile display device 102 to be connected to another device via a suitable HDMI connector and to transmit signals representing video content thereto or signals representing video and audio content thereto. In further accordance with such an embodiment, video interface 116 may be connected to a micro-connector of the type defined in the HDMI 1.4 Specification, although other connector types may be used. Of course, interfaces other than an HDMI interface may be used to implement video interface 116. Such interfaces may include, for example and without limitation, a Video Graphics Array (VGA) interface, a Composite or CVBS interface, an S-Video interface, a Component interface, a Digital Visual Interface (DVI) interface, an SCART interface, a DisplayPort interface, or an IEEE 1394 “FireWire” interface.

Docking interface 114 comprises one or more components of mobile display device 102 that enable mobile display device 102 to be selectively engaged with and disengaged from docking station 104. In particular, a docking interface 124 of docking station 104 is configured to detachably engage docking interface 114 of mobile display device 102, which permits mobile display device 102 to be selectively engaged with and disengaged from docking station 104. As used herein, the phrase “detachably engage” means an engagement that can be selectively broken and re-engaged. Various structures can be employed to achieve this engagement, including pins and accompanying apertures or even contactless interfaces that transfer data via electromagnetic interaction. Mobile display device 102 is considered engaged with docking station 104 when it is possible to transmit and receive signals between docking interface 114 of mobile display device 102 and docking interface 124 of docking station 104. Conversely, mobile display device 102 is considered to be removed or disengaged from docking station 104 when docking interface 114 of mobile display device 102 and docking interface 124 of docking station 104 are not able to receive signals from one another. It must be noted, however, that when mobile display device 102 is removed from docking station 104 in accordance with this principle, mobile display device 102 may still be able to exchange signals with docking station 104 through components other than docking interface 114 and docking interface 124. For example, mobile display device 102 may be capable of exchanging signals with docking station 104 over a wired or wireless connection when removed from docking station 104.

Docking station 104 includes a plurality of components that can be used to extend the capabilities of mobile display device 102 when mobile display device 102 is engaged therewith. For example, docking station 104 includes a power supply 126 that can provide power to mobile display device 102 when mobile display device 102 is engaged therewith. Such power may be used to charge one or more batteries of mobile display device 102. Depending upon the implementation, power supply 126 may comprise, for example, one or more components for routing power received via a Power over Ethernet (POE) connection or via a connection to an AC power source such as a utility, or one or more batteries. Docking station 104 may include a voltage converter for performing the power supply function.

Docking station 104 also includes a user interface 128 through which a user can interact with mobile display device 102 when mobile display device 102 is engaged with docking station 104. In accordance with some embodiments, these user interface components provide a means for interacting with mobile display device 102 that are not provided by mobile display device 102. In an embodiment in which mobile display device provides functionality for placing or receiving a voice call, such user interface components may include components traditionally associated with a desktop phone. By way of example only and without limitation, these components may include a handset that includes a microphone and speaker that a user may use when conducting a voice call, an on/off hook switch, a keypad for entering a phone number or other call-related information, a microphone and a speaker for conducting a voice call in speakerphone mode, and/or a headset connection for facilitating headset calls. These components may also include buttons, dials, or other mechanisms for controlling a volume of a speaker or an input sensitivity of a microphone, for controlling which speaker or speaker(s) audio content is channeled to, or for controlling which microphone or microphone(s) are used to capture audio content. Still further components may be used to indicate the state of various control settings to a user, such as a settings display.

Docking station 104 also includes at least one network interface 130 by which mobile display device 102 can transmit or receive data when mobile display device 102 is engaged with docking station 104. For example, docking station 104 may include one or more interfaces for communicating with a wide area network (WAN) such as the Internet, a local area network (LAN) such as an Ethernet, a wireless local area network (WLAN), a personal area network (PAN) and/or the public switched telephone network (PSTN). In accordance with certain embodiments, network interface 130 may provide access to a network that is not accessible to mobile display device 102 when mobile display device 102 is disengaged from docking station 104. Docking station 104 may also include interfaces for establishing other types of connections, such as Universal Serial Bus (USB) connections or the like.

Docking station 104 further includes a video interface 122. Video interface 122 comprises one or more components that enable docking station 104 to be connected to another device, such as display device 106, for at least the purpose of transmitting signals representing video content thereto. Depending upon the implementation, video interface 122 may be capable of transmitting signals that represent audio content as well as video content, and may further operate to transmit or receive control signals. In one embodiment, video interface 122 comprises a DisplayPort interface that enables docking station 104 to be connected to another device via a suitable DisplayPort connector and to transmit signals representing video content thereto or signals representing video and audio content thereto. Of course, interfaces other than a DisplayPort interface may be used to implement video interface 122. Such interfaces may include, for example and without limitation, a VGA interface, a Composite or CVBS interface, an S-Video interface, a Component interface, a DVI interface, an SCART interface, an HDMI interface, or an IEEE 1394 “FireWire” interface.

Display device 106 is capable of displaying video content that is transmitted to it from docking station 104 or mobile display device 102. In particular, display device 106 includes a video interface 142 that can be connected to video interface 116 of mobile display device 102 using a suitable connector, thereby enabling display device 106 to receive signals that represent at least video content from mobile display device 102. For example, in an embodiment in which video interface 116 comprises an HDMI interface, video interface 142 may also comprise an HDMI interface, such that HDMI signals can be transmitted from mobile display device 102 to display device 106 using a suitable HDMI connector. Display device 106 further includes a processing unit 140 that operates to receive video content from video interface 142 and present it to a display 146 of display device 106.

As further shown in FIG. 1, display device 106 also includes a video interface 144 that can be connected to video interface 122 of mobile display device 102 using a suitable connector, thereby enabling display device 106 to receive signals that represent at least video content from docking station 104. Such video content is received by docking station 104 from mobile display device 102 when mobile display device 102 is engaged therewith. For example, in an embodiment in which video interface 122 comprises a DisplayPort interface, video interface 144 may also comprise a DisplayPort interface, such that DisplayPort signals can be transmitted form docking station 104 to display device 106 using a suitable DisplayPort connector. Processing unit 140 of display device 106 operates to receive video content from video interface 144 and present it to display 146 of display device 106.

Although display device 106 is shown as including video interface 142 that can be connected to video interface 116 of mobile display device 102 and video interface 144 that can be connected to video interface 122 of docking station 104, it is to be understood that display device 106 may include only video interface 142 and thus may only be connected to video interface 116 of mobile display device 102 or may include only video interface 144 and thus may only be connected to video interface 122 of docking station 104. Furthermore, in an embodiment in which video interface 116 of mobile display device 102 and video interface 122 of docking station 104 comprise the same or compatible video interface types, display device 106 may comprise a single video interface that is capable of being connected to either video interface 116 or video interface 122.

Depending upon the implementation, video content that is generated by mobile display device 102 and transmitted to display device 106 for display thereon may be the same as or substantially similar to video content that is generated by mobile display device 102 for presentation to display 150. For example, display 146 of display device 106 may be used to present a “cloned” version of display 150. This may be desired, for example, where display 146 is larger than display 150 and a user simply wishes to obtain a larger view of video content currently being presented to display 150.

This capability can enable mobile display device 105 to be converted into a fairly inexpensive and highly-portable computing device with access to all the benefits of cloud computing. For example, in accordance with one embodiment, a keyboard and mouse may be connected to mobile display device 105 via a wired or wireless link. By using such a configuration and a virtual desktop infrastructure (VDI), a user of display system 100 may be able to simulate the experience of sitting in front of a desktop computer without having a desktop computer. In accordance with such an embodiment, virtual desktop software running on mobile display device 105 communicates with a remote computer over a network interface and is served a desktop therefrom. Mobile display device 105 then routes the desktop to display device 106 (e.g., a monitor) via either video interface 116 of mobile display device 105 or via video interface 122 of docking station 104 when it is engaged therewith. Display device 106 then presents the desktop via display 146.

In an alternate implementation, the video content that is generated by mobile display device 102 and transmitted to display device 106 for display thereon may be different than the video content that is generated by mobile display device 102 for presentation to display 150. This approach enables mobile display device 102 to achieve dual display functionality, with different video content being concurrently presented to display 150 and display 146. As one non-limiting example, display 150 may be used to present video of one or more participants in a video teleconference while display 146 may be used to display a multimedia presentation while the video teleconference is being conducted. A variety of other applications and uses of dual display functionality are known in the art.

In a still further implementation, the video content that is generated by mobile display device 102 and transmitted to display device 106 for display thereon may be a modified version of the video content that is generated by mobile display device 102 for presentation to display 150. For example, enhancements may be added to images included within the video content. Furthermore, non-video components may be added to the video content, such as additional audio or tactile signals. The video content from mobile display device 102 may also be displayed in a picture-in-picture format on display 146.

As further shown in FIG. 1, docking station 104 includes a processing unit 120 that is communicatively connected to both docking interface 124 and video interface 122. As will be described below, processing unit 120 may be used to process video content received from mobile display device 102 via docking interface 124 prior to transmitting such video content to display device 106 via video interface 122. Like processing unit 110 of mobile display device 102, processing unit 120 may represent one or more general-purpose or special-purpose processors or processor cores that are configured to execute instructions in a well-known manner. Processing unit 120 may additionally or alternatively represent one or more application-specific integrated circuits, gate arrays, or other structures designed to perform particular operations.

In an embodiment, processing unit 120 assists in ensuring compatibility between mobile display device 102 and display device 106. For example, processing unit 120 can perform any conversion necessary to ensure that signals received from mobile display device 102 can be displayed by display device 106. For example, processing unit 120 may operate to convert video content from a first video interface format that is supported by mobile display device 102 to a second video interface format that is supported by display device 106. As a particular example, processing unit 120 may operate to convert video content received from mobile display device 102 via docking interface 124 from an HDMI format to a DisplayPort format prior to transmitting such video content to display device 106 via video interface 122. Processing unit 102 may also perform conversions between a variety of other video interface formats as well.

In another embodiment, processing unit 120 operates to ensure that video content that is generated by mobile display device 102 is provided to display device 106 at a display resolution that is supported by display device 106. This may involve, for example, converting the video content from a first display resolution that is supported by mobile display device 102 to a second display resolution that is supported by display device 106 but is not supported by mobile display device 102. Such conversion may involve, for example, upscaling the video content from a lower display resolution to a higher display resolution. For example, if mobile display device 102 is only capable of producing video content having a display resolution of 1280×720 pixels and display device 106 is capable of displaying video content having a display resolution of 1920×1080 pixels, processing unit 120 may operate to convert video content received from mobile display device 102 from a 1280×720 pixels display resolution to video content having a 1920×1080 pixels display resolution prior to transferring the video content to display device 106.

In a further embodiment, processing unit 120 is capable of determining the display resolution capabilities of display device 106 and is further capable of using such information to determine a desired display resolution for video content to be delivered to display device 106. For example, in one embodiment, video interface 122 determines the display resolution capabilities of display device 106 when it is connected thereto via a suitable signaling protocol and then provides such information to processing unit 120. Using such information, processing unit 120 may determine a desired display resolution for video content to be delivered to display device 106 and convert video content received from mobile display device 102 to the desired display resolution whenever necessary.

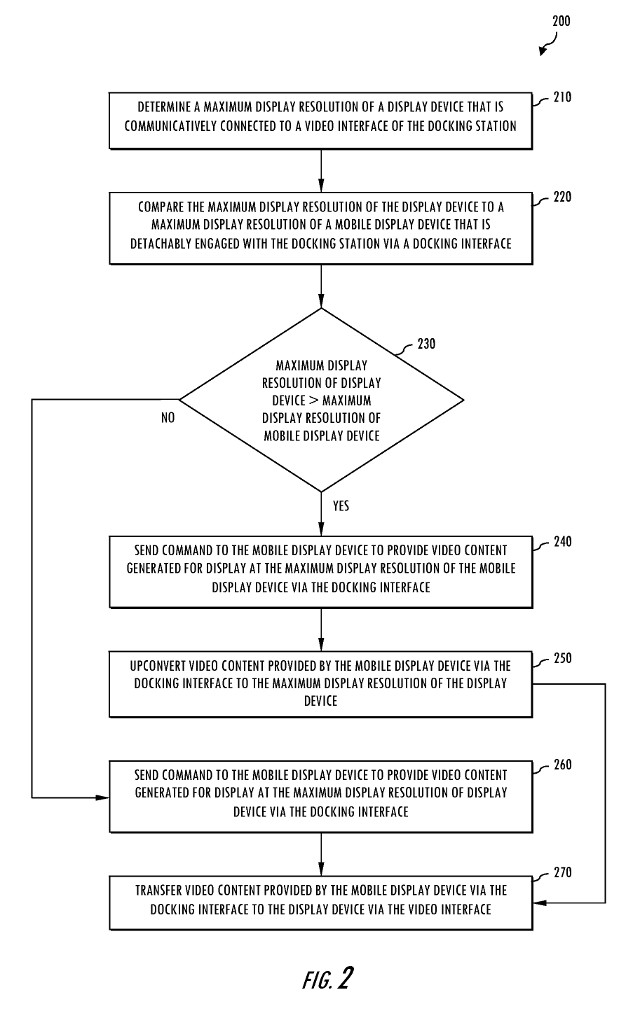

In a still further embodiment, processing unit 120 is capable of determining the display resolution capabilities of mobile display device 102 and the display resolution capabilities of display device 106 and is further capable of using such information to control the display resolution of video content received from mobile display device 102 and/or the display resolution of video content output to display device 106. FIG. 2 depicts a flowchart 200 of a method in accordance with such an embodiment. The method of flowchart 200 will now be described with continued reference to the components of system 100 as described above in reference to FIG. 1. However, the method is not limited to that implementation.

As shown in FIG. 2, the method of flowchart 200 begins at step 210 in which processing unit 120 of docking station 104 determines a maximum display resolution of a display device that is communicatively connected to video interface 122 of docking station 104, such as display device 106.

At step 220, processing unit 120 compares the maximum display resolution of the display device connected to video interface 122 to a maximum display resolution of mobile display device 102 that is detachably engaged with docking station 104 via docking interface 124.

As shown at decision step 230, if the maximum display resolution of the display device that is connected to video interface 122 exceeds the maximum display resolution of mobile display device 102, then control flows to step 240, during which processing unit 120 sends a command to mobile display device 102 to provide video content generated for display at the maximum display resolution of mobile display device 102. In this instance, since the video content provided from mobile display device 102 will have a lower display resolution than that of the display device connected to video interface 122, processing unit 120 can upscale the video content to the higher display resolution of the display device as shown at step 250. After step 250, control flows to step 270 during which processing unit 120 transfers the video content provided by mobile display device 102 (and potentially upscaled by processing unit 120 during step 250) to the display device connected to video interface 122.

As also shown at decision step 230, if the maximum display resolution of the display device that is connected to video interface 122 does not exceed the maximum display resolution of mobile display device 102, then control instead flows to step 260, during which processing unit 120 sends a command to mobile display device 102 to provide video content generated for display at the maximum display resolution of the display device connected to video interface 122. This step encompasses situations in which the maximum display resolution of both devices is equal and thus no conversion need be carried out. This step also encompasses situations in which the display device connected to video interface 122 cannot display video content at the maximum resolution supported by mobile display device 102, in which case there is no need for mobile display device 102 to provide video content at its maximum display resolution. Thus, by commanding mobile display device 102 to produce video content at a display resolution that is lower than its maximum resolution, processing unit 120 can help mobile display device conserve processing power. After step 250, control flows to step 270 during which processing unit 120 transfers the video content provided by mobile display device 102 to the display device via video interface 122.

Note that processing unit 120 may convert other signal parameters, such as frame rates and clock rates, to enable signals representative of video content received from mobile display device 102 to be displayed by display device 106. In another arrangement, mobile display device 102 and display device 106 may be capable of supporting multiple video interface formats, display resolutions, or other parameters. In this case, processor 120 can be operable to select which of the available formats/display resolutions/parameters should be employed during any necessary conversion. Other entities, such as a component in mobile display device 102 or display device 106, may be responsible for selecting the formats/display resolutions/parameters for the conversion. In this arrangement, the selecting entity can be made aware of the various signal types that are supported by mobile display device 102 and display device 106.

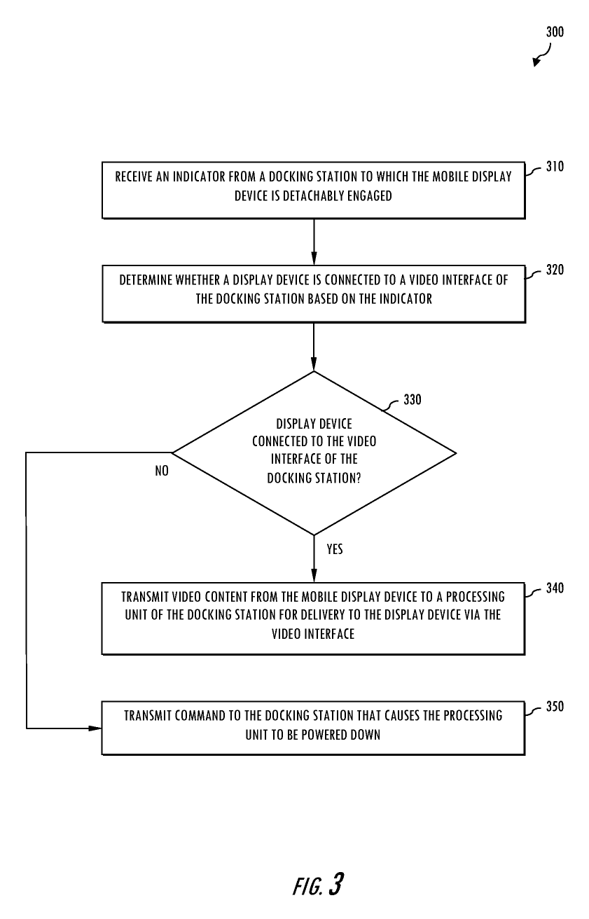

In an additional embodiment, processing unit 120 can be selectively powered down by mobile display device 102 when mobile display device 102 determines that there is no display device connected to video interface 122 of docking station 104. This helps to conserve power consumed by docking station 104. FIG. 3 depicts a flowchart of a method in accordance with such an embodiment. The method of flowchart 300 will now be described with continued reference to the components of system 100 as described above in reference to FIG. 1. However, the method is not limited to that implementation.

As shown in FIG. 3, the method of flowchart 300 begins at step 310 in which processing unit 110 of mobile display device 102 receives an indicator from docking station 104 to which mobile display device 102 is detachably engaged. This indicator may be produced, for example, by processing unit 120, video interface 122, or some other component within docking station 104 and transmitted to processing unit 110 via docking interface 114 or some other connection.

At step 320, processing unit 110 determines whether a display device is connected to video interface 122 of docking station 104 based on the indicator received during step 310.

As shown at decision step 330, if processing unit 110 determines that a display device is connected to video interface 122 of docking station 104 then control flows to step 340, during which processing unit 110 transmits video content from mobile display device 102 to processing unit 120 of docking station 104 for delivery to the display device via video interface 122.

As also shown at decision step 330, if processing unit 110 determines that a display device is not connected to video interface 122 of docking station 104 then control flows to step 350, during which processing unit 110 transmits a command to docking station 114 that causes processing unit 120 of docking station 104 to be powered down. Such command may be transmitted via docking interface 114 and docking interface 124 or via some other connection between mobile display device 102 and docking station 104.

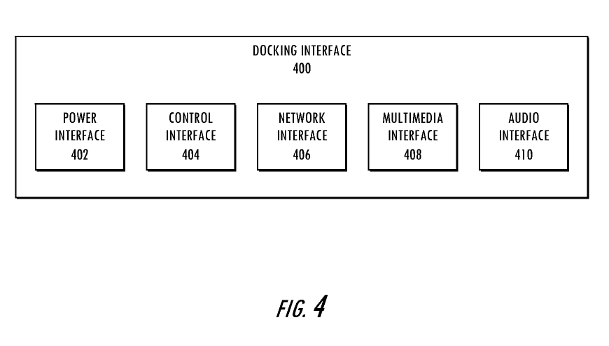

FIG. 4 is a block diagram of an example docking interface 400 that can be used to implement docking interfaces 114 and 124 of FIG. 1 in accordance with an embodiment. As shown in FIG. 4, docking interface 400 includes a plurality of separate interfaces including a power interface 402, a control interface 404, a network interface 406, a multimedia interface 408 and an audio interface 410. Power interface 402 includes one or more connections for carrying power signals from docking station 104 to mobile display device 102. Control interface 404 includes one or more connections for carrying control signals between mobile display device 102 and docking station 104. Network interface 406 includes one or more connections for carrying network-related data between mobile display device 102 and docking station 104. Multimedia interface 408 includes one or more connections for carrying video content and/or audio content from mobile display device 102 to docking station 104 and for carrying related control signals there between. Audio interface 410 includes one or more connections for carrying audio content between mobile display device 102 and docking station 104.

It is to be understood that system 100 can include any suitable number of mobile display devices 102, docking stations 104 and display devices 106. For example, one mobile display device 102 may be able to provide video content to multiple display devices 106, which may be serially (daisy-chained) or independently connected to mobile display device 102. It is also noted that the connections between mobile display device 102, docking station 104 and display device 106 may or may not be bi-directional.

Each of mobile display device 102, docking station 104, and display device 106, as well as any of the sub-systems or components contained therein may be implemented in hardware, software, firmware, or any combination thereof. For example, each of mobile display device 102, docking station 104, and display device 106, as well as any of the sub-systems or components contained therein may be implemented as computer program code configured to be executed in one or more processors. Alternatively, each of mobile display device 102, docking station 104, and display device 106, as well as any of the sub-systems or components contained therein as hardware logic/electrical circuitry.

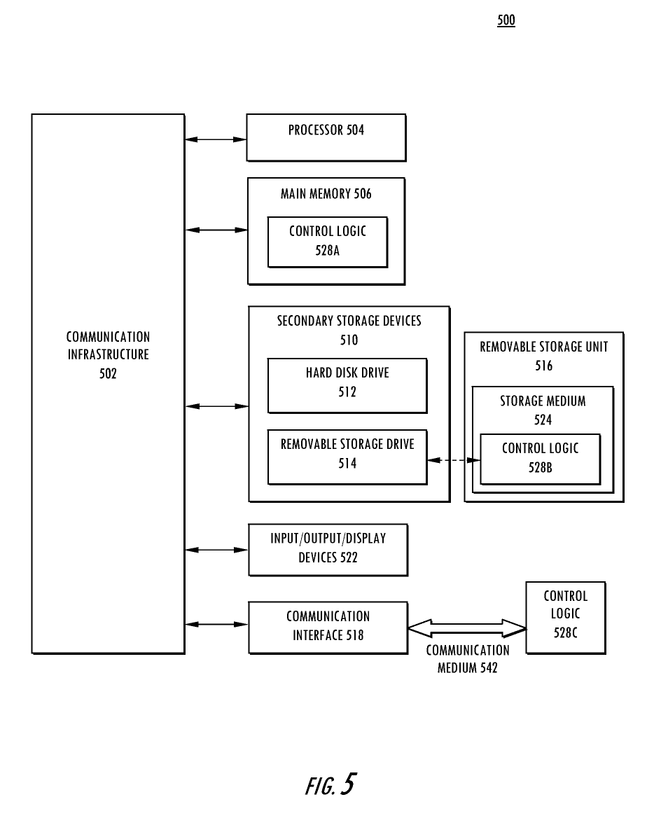

The embodiments described herein, including systems, methods/processes, and/or apparatuses, may be implemented using well known servers/computers, such as a computer 500 shown in FIG. 5. For example, each of mobile display device 102, docking station 104, and display device 106, as well as any of the sub-systems or components contained therein may be implemented using one or more computers 500.

Computer 500 can be any commercially available and well known computer capable of performing the functions described herein, such as computers available from International Business Machines, Apple, Sun, HP, Dell, Cray, etc. Computer 500 may be any type of computer, including a desktop computer, a server, etc.

Computer 500 includes one or more processors (also called central processing units, or CPUs), such as a processor 504. Processor 504 is connected to a communication infrastructure 502, such as a communication bus. In some embodiments, processor 504 can simultaneously operate multiple computing threads.

Computer 500 also includes a primary or main memory 506, such as random access memory (RAM). Main memory 506 has stored therein control logic 528A (computer software), and data.

Computer 500 also includes one or more secondary storage devices 510. Secondary storage devices 510 include, for example, a hard disk drive 512 and/or a removable storage device or drive 514, as well as other types of storage devices, such as memory cards and memory sticks. For instance, computer 500 may include an industry standard interface, such a universal serial bus (USB) interface for interfacing with devices such as a memory stick. Removable storage drive 500 represents a floppy disk drive, a magnetic tape drive, a compact disk drive, an optical storage device, tape backup, etc.

Removable storage drive 514 interacts with a removable storage unit 516. Removable storage unit 516 includes a computer useable or readable storage medium 524 having stored therein computer software 528B (control logic) and/or data. Removable storage unit 516 represents a floppy disk, magnetic tape, compact disk, DVD, optical storage disk, or any other computer data storage device. Removable storage drive 514 reads from and/or writes to removable storage unit 516 in a well known manner.

Computer 500 also includes input/output/display devices 522, such as monitors, keyboards, pointing devices, etc.

Computer 500 further includes a communication or network interface 518. Communication interface 518 enables computer 500 to communicate with remote devices. For example, communication interface 518 allows computer 500 to communicate over communication networks or mediums 542 (representing a form of a computer useable or readable medium), such as LANs, WANs, the Internet, etc. Communication interface 518 may interface with remote sites or networks via wired or wireless connections.

Control logic 528C may be transmitted to and from computer 500 via communication medium 542.

Any apparatus or manufacture comprising a computer useable or readable medium having control logic (software) stored therein is referred to herein as a computer program product or program storage device. This includes, but is not limited to, computer 500, main memory 506, secondary storage devices 510, and removable storage unit 516. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing the features of each of mobile display device 102, docking station 104, and/or display device 106, as well as any of the sub-systems or components contained therein, any of the methods or steps of the flowcharts of FIGS. 2 and 3, and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### C. Conclusion

While various embodiments have been described above, it should be understood that they have been presented by way of example only, and not limitation. It will be understood by those skilled in the relevant art(s) that various changes in form and details may be made therein without departing from the spirit and scope of the appended claims. Accordingly, the breadth and scope of the subject matter described herein should not be limited by any of the above-described exemplary embodiments, but should be defined only in accordance with the following claims and their equivalents.

What is claimed is:

1. A display system, comprising:
a mobile display device comprising a first processing unit, a first display configured to display first video content generated by the first processing unit, and a first docking interface; and
a docking station comprising a second docking interface, a second processing unit and a first video interface, the second docking interface being configured to detachably engage the first docking interface, thereby permitting the mobile display device to be selectively engaged with and disengaged from the docking station, the first video interface being configured to be connected to a second video interface of a display device;
wherein the second processing unit is configured to receive second video content generated by the first processing unit via the first and second docking interfaces and to transmit the second video content to the display device for display thereby via the first and second video interfaces when the mobile display device is engaged with the docking station and the first video interface is connected to the second video interface.

2. The system of claim 1 wherein the display device comprises a second display that is larger than the first display and is configured to display the second video content.

3. The system of claim 1, wherein the second video content is the same as the first video content.

4. The system of claim 1, wherein the second video content is different than the first video content.

5. The system of claim 1, wherein the first video interface and the second video interface each comprise a DisplayPort interface.

6. The system of claim 1, wherein the docking station is configured to transmit an indicator to the first processing unit when the mobile display device is engaged with the docking station, the indicator indicating whether a display device is connected to the first video interface;
wherein the first processing unit is configured to cause the second processing unit to be powered down in response to determining that no display device is connected to the first video interface.

7. The system of claim 1, wherein the second processing unit is configured to convert the second video content from a first video interface format to a second video interface format.

8. The system of claim 7, wherein the second processing unit is configured to convert the second video content from a High-Definition Multimedia Interface (HDMI) format to a DisplayPort format.

9. The system of claim 1, wherein the second processing unit is configured to convert the second video content from a first display resolution that is supported by the mobile display device to a second display resolution that is supported by the display device but is not supported by the mobile display device.

10. The system of claim 9, wherein the second processing unit is configured to convert the second video content by upscaling the second video content.

11. The system of claim 1, wherein the second processing unit is configured to determine a maximum display resolution of the display device and, if the maximum display resolution of the display device exceeds a maximum display resolution of the mobile display device, to command the first processing unit to generate the second video content for display at the maximum display resolution of the mobile display device.

12. The system of claim 1, wherein the second processing unit is configured to determine a maximum display resolution of the display device and, if the maximum display resolution of the display device does not exceed a maximum display resolution of the mobile display device, to command the first processing unit to generate the second video content for display at the maximum display resolution of the display device.

13. The system of claim 1, wherein the mobile display device further comprises a third video interface that enables the mobile display device to be directly connected to a display device and transmit video content thereto.

14. The system of claim 13, wherein the third video interface comprises a High-Definition Multimedia Interface (HDMI).

15. A method implemented by a docking station, comprising:
determining a maximum display resolution of a display device that is communicatively connected to a video interface of the docking station;
comparing the maximum display resolution of the display device to a maximum display resolution of a mobile display device that is detachably engaged with the docking station via a docking interface;
in response to determining that the maximum display resolution of the display device exceeds the maximum display resolution of the mobile display device, sending a command to the mobile display device to provide video content generated for display at the maximum display resolution of the mobile display device via the docking interface;
in response to determining that the maximum display resolution of the display device does not exceed the maximum display resolution of the mobile display device, sending a command to the mobile display device to provide video content generated for display at the maximum display resolution of the display device; and
transferring video content provided by the mobile display device via the docking interface to the display device via the video interface.

16. The method of claim 15, further comprising:
in response to determining that the maximum display resolution of the display device exceeds the maximum display resolution of the mobile display device, upscaling the video content provided by the mobile display device via the docking interface prior to transferring the video content to the display device via the video interface.

17. The method of claim 15, further comprising:
converting the video content from a first video interface format to a second video interface format prior to transferring the video content to the display device via the video interface.

18. The method of claim 15, wherein converting the video content from the first video interface format to the second video interface format comprises converting the video content from a High-Definition Multimedia Interface (HDMI) format to a DisplayPort format.

19. A method implemented by a mobile display device that is detachably engaged to a docking station, comprising:
receiving an indicator from the docking station;
based on the indicator, determining whether a display device is connected to a video interface of the docking station;
in response to determining that a display device is connected to the video interface of the docking station, transmitting video content from the mobile display device to a processing unit of the docking station for delivery to the display device via the video interface;
in response to determining that no display device is connected to the video interface of the docking station, transmitting a command to the docking station that causes the processing unit of the docking station to be powered down.

20. The method of claim 19, wherein transmitting video content from the mobile display device to the processing unit of the docking station comprises transmitting a copy of video content that is also being displayed on a display of the mobile display device.

21. The method of claim 19, wherein transmitting video content from the mobile display device to the processing unit of the docking station comprises transmitting video content that is different from video content being displayed on a display of the mobile display device.

22. The method of claim 19, wherein determining whether a display device is connected to the video interface of the docking station comprises determining whether a display device is connected to a DisplayPort interface of the docking station.

23. A display system, comprising:
a mobile display device comprising a first processing unit, a first display configured to display first video content generated by the first processing unit, and a first docking interface;
a docking station comprising a second docking interface, a second processing unit and a first video interface, the second docking interface being configured to detachably engage the first docking interface, thereby permitting the mobile display device to be selectively engaged with and disengaged from the docking station; and
a display device comprising a second video interface configured to be connected to the first video interface;
wherein the second processing unit is configured to receive second video content generated by the first processing unit via the first and second docking interfaces and to transmit the second video content to the display device for display thereby via the first and second video interfaces when the mobile display device is engaged with the docking station and the second video interface is connected to the first video interface.

24. A docking station, comprising:
a first docking interface configured to detachably engage a second docking interface of a mobile display device, thereby permitting the mobile display device to be selectively engaged with and disengaged from the docking station;
a first processing unit; and
a first video interface configured to be connected to a second video interface of a display device;
wherein the first processing unit is configured to receive video content generated by a second processing unit of the mobile display device via the first and second docking interfaces and to transmit the video content to the display device for display thereby via the first and second video interfaces when the mobile display device is engaged with the docking station and the first video interface is connected to the second video interface.
